(19) United States
(12) Patent Application Publication
(10) Pub. No.: US 2024/0012117 A1
(43) Pub. Date: Jan. 11, 2024

(54) Detection Method and Apparatus

(71) Applicant: Huawei Technologies Co., Ltd., Shenzhen (CN)

(72) Inventors: Hongliang Wang, Shenzhen (CN); Wei Wang, Shanghai (CN); Aijuan Zhang, Shanghai (CN); Anliang Yu, Shanghai (CN); Yuemeng Wang, Shanghai (CN); Kai An, Wuhan (CN); Riliang Su, Shanghai (CN); Bingcheng Du, Shenzhen (CN)

(21) Appl. No.: 18/471,713

(22) Filed: Sep. 21, 2023

Related U.S. Application Data
(63) Continuation of application No. PCT/CN2021/082590, filed on Mar. 24, 2021.

(51) Int. Cl. G01S 7/481

(52) U.S. Cl. CPC G01S 7/4817; G01S 7/4815

(57) ABSTRACT

A detection apparatus includes a scanning system, the scanning system includes a micro reflector array, and the micro reflector array includes M micro reflectors. The detection apparatus further includes P transceiver modules. An optical signal sent by the P transceiver modules is reflected by the M micro reflectors, and/or the P transceiver modules receive an optical signal reflected by the M micro reflectors. The P transceiver modules do not need to receive and send signals using one micro reflector, but may receive and send signals by using the M micro reflectors.

### CROSS-REFERENCE TO RELATED APPLICATIONS

This application is a continuation application of International Patent Application No. PCT/CN2021/082590 filed on Mar. 24, 2021, the disclosure of which is hereby incorporated by reference in its entirety.

### TECHNICAL FIELD

This application relates to the field of detection technologies, and in particular, to a detection method and apparatus.

### BACKGROUND

Light detection and ranging or laser imaging, detection, and ranging (Lidars) have a medium- and long-distance environment perception capability beyond a human visual perception range, and therefore are widely used in fields such as unmanned driving, mapping, and robots. The lidars are usually divided into two categories: a mechanical lidar and a solid-state lidar. Although the mechanical lidar can implement large-angle scanning, a scanning frequency is low. In addition, because a scanning component of the mechanical lidar is large in size, system stability is limited. Compared with the mechanical lidar, the solid-state lidar has advantages of good stability, excellent shock resistance, high integration, and the like, and therefore is widely used.

A lidar based on a micro-electro-mechanical system (MEMS) micromirror is a typical solid-state lidar. The MEMS micromirror is a micro-scanning component designed based on a micro-electro-mechanical principle and has a specific degree of integration. Compared with that of a conventional mechanical scanning component, stability of the micro-scanning component is further improved. The solid-state lidar is usually provided with a MEMS micromirror, and the MEMS micromirror is disposed at front ends of a plurality of transceiver modules. The transceiver modules generally have a transmitting-receiving coaxial structure. In this structure, an optical signal sent by the transceiver module and an optical signal received by the transceiver module pass through a same path. Light emitted by the plurality of transceiver modules is reflected to space by using the MEMS micromirror, and light received by the MEMS micromirror also separately enters the plurality of transceiver modules.

As a quantity of transceiver modules increases, the MEMS micromirror needs to reflect more optical signals. In this case, in an area with a longer distance from a central field of view, a distortion of a point cloud formed by the optical signals reflected by the MEMS micromirror is greater. Consequently, optical signals received and sent by the solid-state lidar are distorted, and signal accuracy is reduced.

### SUMMARY

Embodiments of this application provide a detection method and apparatus, to improve accuracy of signals received and sent by a detection apparatus.

According to a first aspect, a detection apparatus is provided. The detection apparatus includes a scanning system and P transceiver modules. The scanning system includes a micro reflector array, and the micro reflector array includes M micro reflectors. An optical signal sent by the P transceiver modules is reflected by the M micro reflectors, and/or the P transceiver modules receive an optical signal reflected by the M micro reflectors. M is an integer greater than or equal to 2, and P is a positive integer less than or equal to M.

In this embodiment of this application, the M micro reflectors are disposed in the detection apparatus, and M is an integer greater than or equal to 2. Therefore, the P transceiver modules do not need to receive and send signals by using one micro reflector, but may receive and send signals by using the M micro reflectors. In this way, a distortion degree of a point cloud formed by optical signals reflected by the micro reflectors is reduced, and accuracy of optical signals received and sent by the detection apparatus is improved. In addition, because the plurality of micro reflectors is disposed, and each micro reflector may correspond to a corresponding transceiver module, a quantity of transceiver modules may accordingly be increased, so that a larger field of view can be obtained through splicing by using more transceiver modules. In this way, the detection apparatus can detect a larger field of view, and a detection range of the detection apparatus is expanded. In addition, because the plurality of micro reflectors is disposed, and each micro reflector may correspond to the corresponding transceiver module, when a rotation angle of a micro reflector is adjusted, a scanning angle of an optical signal reflected by the micro reflector in space can be changed, that is, an angle of view of a transceiver module corresponding to the micro reflector in space can be changed. In this way, a size of a field of view of the transceiver module corresponding to the micro reflector in space can be adjusted. For example, to focus on some target objects in a field of view, a rotation angle of a micro reflector corresponding to the field of view may be adjusted to reduce an angle of view of the field of view, so as to reduce the field of view. In this way, detection of some target objects can be more flexibly. After the field of view is reduced, there may be a gap between the field of view and another field of view. Therefore, a rotation angle of a micro reflector corresponding to the other field of view may be adjusted to increase a size of the other field of view, so that the other field of view can cover a reduced area of the field of view, thereby better implementing seamless splicing between fields of view and improving detection coverage of the detection apparatus.

In an optional implementation, the detection apparatus further includes N beam expansion systems. A portion of or all optical signals sent by the P transceiver modules arrive at the N beam expansion systems through one or more of the M micro reflectors, and/or the P transceiver modules receive an optical signal that arrives at one or more of the M micro reflectors through the N beam expansion systems and then is reflected by the one or more micro reflectors. The N beam expansion systems are used to change the detection range, and N is a positive integer less than or equal to M. A transceiver module can detect a specific field of view. However, because a diameter of the micro reflector is small, for example, the diameter of the micro reflector is generally at a nanometer level, a receiving aperture of the micro reflector is small, and energy of a received optical signal is small. Consequently, a detection distance of the transceiver module is limited. According to this embodiment of this application, a beam expansion system may be disposed for a transceiver module whose detection distance needs to be expanded. If a beam expansion system is disposed for a transceiver module, it is equivalent to increasing a receiving aperture of a detection channel corresponding to the transceiver module, so that energy of an optical signal received by the transceiver module can be increased. In this way, a detection distance of the transceiver module can be increased, and it is equivalent to expanding a detection range of the transceiver module. Therefore, a beam expansion system may be disposed for a transceiver module that needs to perform long-distance detection, and a beam expansion system may not be disposed for a transceiver module that needs to perform short-distance detection, so that the detection apparatus can implement detection at different distances, thereby improving detection flexibility.

In an optional implementation, the N beam expansion systems include a first beam expansion system. An optical signal sent by a first transceiver module arrives at the first beam expansion system through a first micro reflector, and/or the first transceiver module receives an optical signal that arrives at the first micro reflector through the first beam expansion system and then is reflected by the first micro reflector. The first transceiver module is one of the P transceiver modules. The first micro reflector is one of the M micro reflectors, and the first micro reflector is located in a middle position of the M micro reflectors. The central field of view is usually a key field of view for detection. For the central field of view, long-distance detection may be required. Therefore, a beam expansion system may be disposed at a front end of a micro reflector corresponding to the central field of view, to expand a detection range of the central field of view, so as to meet a detection requirement.

In an optional implementation, one of the P transceiver modules includes a laser, a collimation system, a first optical splitting system, and a receiving system. The transceiver module may use a transmitting-receiving coaxial structure, or may use a transmitting-receiving off-axis structure.

In an optional implementation, when P is less than M, the detection apparatus further includes a second optical splitting system, and the second optical splitting system is configured to split H optical signals sent by H transceiver modules in the P transceiver modules into K optical signals. H is an integer greater than or equal to 1 and less than or equal to P, and K is an integer greater than or equal to 2 and less than or equal to M. For example, if P is greater than 1, but P is less than M, the detection apparatus may include a plurality of transceiver modules, one of the transceiver modules may correspond to one or more of the M micro reflectors, and the plurality of transceiver modules correspond to the M micro reflectors in total. If P is less than M, a quantity of transceiver modules included in the detection apparatus may be reduced, to reduce the size of the detection apparatus and reduce costs of the detection apparatus. When P is less than M, the detection apparatus may further include the second optical splitting system. For example, the second optical splitting system may split the H optical signals sent by the H transceiver modules into the K optical signals, so that the K optical signals arrive at K micro reflectors in the M micro reflectors, or may combine K optical signals that are from space and reflected by the K micro reflectors into H optical signals, so that the H optical signals arrive at the H transceiver modules.

In an optional implementation, at least one of the M micro reflectors is a MEMS reflector. In other words, if a diameter of the at least one of the M micro reflectors is less than or equal to a first threshold, it indicates that the diameter of the at least one micro reflector is small. Alternatively, the micro reflector included in the micro reflector array may be another type of micro reflector.

In an optional implementation, when P is equal to M, the optical signal sent by the first transceiver module is reflected by the first micro reflector corresponding to the first transceiver module, and/or the first transceiver module receives the optical signal reflected by the first micro reflector corresponding to the first transceiver module. The first transceiver module is any one of the P transceiver modules. The first micro reflector is any one of the M micro reflectors. The P transceiver modules are in a one-to-one correspondence with the M micro reflectors. When P is equal to M, the transceiver modules are in a one-to-one correspondence with the micro reflectors. Optical signals received and sent by different transceiver modules are reflected by different micro reflectors, and there is no need to split, by using an optical splitting system, an optical signal sent by one transceiver module into a plurality of optical signals for reflection by different micro reflectors. In this way, the optical signals reflected by the micro reflectors are all complete optical signals from corresponding transceiver modules, and power of such optical signals is higher, so that detection of each transceiver module is more accurate.

According to a second aspect, a detection method is provided. The method may be applied to a detection apparatus. The detection apparatus includes P transceiver modules and a micro reflector array, and the micro reflector array includes M micro reflectors. M is an integer greater than or equal to 2, and P is a positive integer less than or equal to M. The P transceiver modules send at least one optical signal, the M micro reflectors reflect the at least one optical signal, and the P transceiver modules receive an echo of the at least one optical signal reflected by the M micro reflectors. Optionally, the detection apparatus is the detection apparatus provided in the first aspect or any optional implementation.

In an optional implementation, the detection apparatus further includes N beam expansion systems. A portion of or all optical signals in the at least one optical signal arrive at the N beam expansion systems after being reflected by one or more of the M micro reflectors, and then are transmitted by the N beam expansion systems. That the P transceiver modules receive an echo of the at least one optical signal reflected by the M micro reflectors includes the following. The P transceiver modules receive an echo of the portion of or all optical signals that arrives at one or more of the M micro reflectors through the N beam expansion systems and then is reflected by the one or more micro reflectors.

In an optional implementation, the N beam expansion systems adjust a focal length, to change a scanning angle of the portion of or all optical signals in space. The beam expansion system is a beam expansion system that can change a distance, and a size of a field of view corresponding to the beam expansion system can be adjusted by changing the distance. In other words, in this embodiment of this application, the beam expansion system is provided, so that not only a detection range can be expanded, but also a size of a field of view can be adjusted.

In an optional implementation, the micro reflector array adjusts a rotation angle of at least one of the M micro reflectors, to change a scanning angle of an optical signal reflected by the at least one micro reflector in space. For example, a beam expansion system is disposed at a front end of a micro reflector in a central field of view. To detect a target object of interest in the central field of view, the central field of view needs to be reduced. The central field of view may be reduced by reducing an angle of view of the central field of view. For example, a focal length of the beam expansion system disposed at the front end of the micro reflector in the central field of view may be adjusted, to reduce the angle of view of the central field of view. After the angle of view of the central field of view is reduced, if an angle of view of a field of view detected by another transceiver module is not adjusted, a blind area may appear between the fields of view, and each transceiver module cannot detect the area. Therefore, an angle of view corresponding to at least one remaining transceiver module in the P transceiver modules other than the transceiver module corresponding to the central field of view may be adjusted, to reduce a blind area between fields of view detected by the P transceiver modules as much as possible. If no beam expansion system is disposed at a front end of at least one micro reflector corresponding to at least one transceiver module, a rotation angle of the at least one micro reflector may be adjusted to adjust an angle of view of a field of view detected by the at least one transceiver module. In this manner, the blind area between the fields of view can be reduced, and spatial detection coverage of the detection apparatus can be improved.

In an optional implementation, after the rotation angle of the at least one of the M micro reflectors is adjusted, the scanning angle of the optical signal reflected by the at least one micro reflector in space is increased, and there is no blind area between a field of view formed in space by the portion of or all optical signals and a field of view formed in space by the optical signal reflected by the at least one micro reflector. Because the central field of view is reduced, the field of view detected by the at least one transceiver module may correspondingly increase, so that the field of view detected by the at least one transceiver module covers a reduced part of the central field of view as much as possible.

In an optional implementation, after the N beam expansion systems adjust the focal length, the scanning angle of the portion of or all optical signals in space is reduced. For example, if a small target in the central field of view needs to be detected, or a small target in the central field of view needs to be focused on, the focal length of the beam expansion system corresponding to the central field of view is adjusted, so that the central field of view can be reduced, to better detect the small target.

In an optional implementation, the transceiver module includes a laser, a collimation system, a first optical splitting system, and a receiving system.

In an optional implementation, when P is less than M, the detection apparatus further includes a second optical splitting system. The second optical splitting system splits H optical signals in the at least one optical signal into K optical signals, and the H optical signals are from H transceiver modules in the P transceiver modules. H is an integer greater than or equal to 1 and less than or equal to P, and K is an integer greater than or equal to 2 and less than or equal to M. That the M micro reflectors reflect the at least one optical signal includes: K micro reflectors reflect the H optical signals, and M-K micro reflectors in the M micro reflectors reflect P−H optical signals in the at least one optical signal.

In an optional implementation, the first micro reflector is a MEMS reflector.

For technical effect brought by the second aspect or some optional implementations of the second aspect, refer to the descriptions of the technical effect brought by the first aspect or the corresponding implementations.

According to a third aspect, a radar is provided, and the radar may include the detection apparatus according to the first aspect.

According to a fourth aspect, a vehicle is provided, and the vehicle may include the detection apparatus according to the first aspect, or the vehicle may include the radar according to the third aspect.

According to a fifth aspect, a computer-readable storage medium is provided. The computer-readable storage medium is configured to store a computer program or instructions, and when the computer program or the instructions is/are run, the method according to the second aspect is implemented.

According to a sixth aspect, a computer program product including instructions is provided. When the computer program product runs on a computer, the method according to the second aspect is implemented.

### BRIEF DESCRIPTION OF DRAWINGS

FIG. 1A is a schematic diagram of a structure of an optical module in which receiving and sending are coaxial;

FIG. 1B is a schematic diagram of a structure of an optical module in which receiving and sending are off-axis;

FIG. 2 is a schematic diagram of a MEMS reflector;

FIG. 3 is a schematic diagram of reflection performed by a plurality of optical modules by using one MEMS reflector;

FIG. 4 is a schematic diagram of splicing point clouds of optical signals transmitted by a plurality of optical modules;

FIG. 5 is a schematic diagram of a detection apparatus according to an embodiment of this application;

FIG. 6A, FIG. 6B, and FIG. 6C are several schematic diagrams of a detection apparatus when P is less than M according to an embodiment of this application;

FIG. 7A and FIG. 7B are two schematic diagrams of a detection apparatus including a zoom beam expansion system according to an embodiment of this application;

FIG. 7C is a schematic diagram of splicing fields of view after adjusting a central field of view according to an embodiment of this application;

FIG. 7D is a schematic diagram of splicing fields of view after adjusting a plurality of fields of view according to an embodiment of this application;

FIG. 7E is a schematic diagram of splicing fields of view before adjusting a central field of view when a plurality of zoom beam expansion systems are included according to an embodiment of this application;

FIG. 7F is a schematic diagram of splicing fields of view after adjusting a central field of view when a plurality of zoom beam expansion systems are included according to an embodiment of this application;

FIG. 7G is a schematic diagram of splicing fields of view after adjusting a plurality of fields of view when a plurality of zoom beam expansion systems are included according to an embodiment of this application;

FIG. 8 is a flowchart of a detection method according to an embodiment of this application; and

FIG. 9A and FIG. 9B are two schematic diagrams of receiving and transmitting optical signals by a transceiver module according to an embodiment of this application.

### DESCRIPTION OF EMBODIMENTS

To make objectives, technical solution, and advantages of embodiments of this application clearer, the following further describes embodiments of this application in detail with reference to the accompanying drawings.

The following describes some terms in embodiments of this application, to facilitate understanding of a person skilled in the art.
(1) A detection apparatus, or referred to as a detector, is, for example, a radar, a functional component disposed in a radar, a large device including a radar, an independent device, or a functional component disposed in another device other than a radar.
(2) A radar includes, for example, a radar and/or a lidar. The radar may also be referred to as a radar apparatus, or may be referred to as a radar detection apparatus, a radar signal sending apparatus, or the like. A working principle of the radar is to detect a corresponding target object by transmitting a signal (or referred to as a detection signal) and receiving a reflected signal reflected by the target object. The signal transmitted by the radar may be an electromagnetic wave signal, a laser beam, or the like. Correspondingly, the received reflected signal reflected by the target object may also be an electromagnetic wave signal, a laser beam signal, or the like. The radar may be used to obtain information such as a distance between the target object and a launch point, a distance change rate (a radial velocity), an azimuth, and a height.
(3) An area of interest, or referred to as a key detection area, is an area that is mainly detected by a detection apparatus, for example, a front of the detection apparatus.
(4) A field of view, or referred to as a field of view range, is a range formed after an optical signal sent by a transceiver module (or referred to as an optical module) reaches space, or a range in which a detection apparatus receives an optical signal corresponding to a transceiver module.
(5) An angle of view is a field-of-view angle, for example, a scanning angle of an optical signal sent by a transceiver module in space. The angle of view may determine a size of a field of view. Generally, a larger angle of view indicates a larger field of view, and a smaller angle of view indicates a smaller field of view. If a field of view needs to be adjusted, an angle of view of the field of view may also be adjusted.
(6) A central field of view is a field of view range of a key detection area.
(7) Field of view splicing means that a plurality of transceiver modules may detect fields of view in a specific range, and a large field of view may be formed by splicing the fields of view. Therefore, it may be considered that an optical system includes a plurality of optical modules, and the optical system may implement detection of a large field of view.
(8) A dual detection mode means that for a lidar optical system, there are two distance measurement modes, namely, long-distance measurement and short-distance measurement.
(9) An optical module is alternatively referred to as a transceiver module or the like. The optical module may use a transmitting-receiving coaxial structure or a transmitting-receiving off-axis structure. In the transmitting-receiving coaxial structure, an optical signal sent by the optical module and an optical signal received by the optical module pass through a same path in the optical module. An optical module may include a laser, a collimation system, a first optical splitting system, and a receiving system. The laser, the collimation system, and the first optical splitting system may belong to a transmitting system, and the receiving system may further include a detector. In the transceiver off-axis structure, an optical signal sent by the optical module and an optical signal received by the optical module pass through different paths. An optical module may include a laser, a collimation system, and a receiving system. The laser and the collimation system may belong to a transmitting system, and the receiving system may further include a detector.

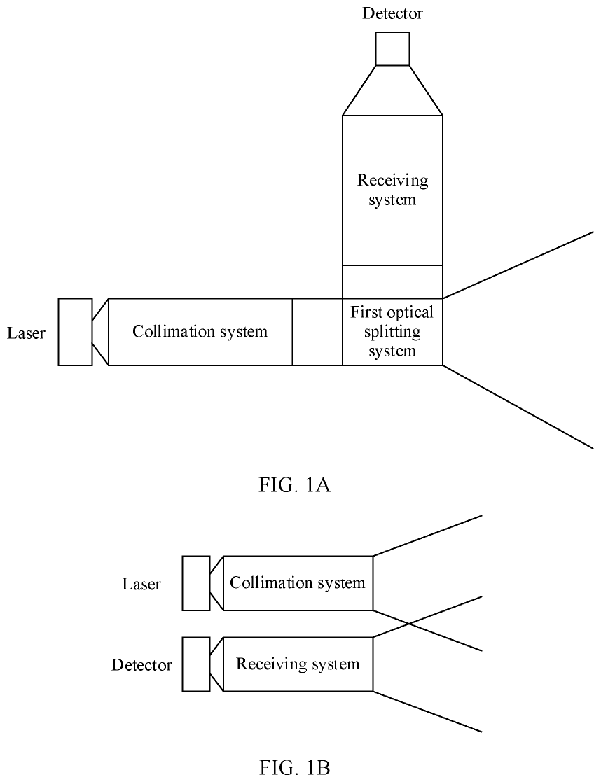

For example, refer to FIG. 1A and FIG. 1B. FIG. 1A is an optical module in which receiving and sending are coaxial, and FIG. 1B is an optical module in which receiving and sending are off-axis. In FIG. 1A, an optical signal sent by a laser is collimated by a collimation system, to regulate a propagation direction of the optical signal, so that the optical signal is propagated forward as much as possible. The optical signal passes through a first optical splitting system, and then is emitted into space by using the first optical splitting system. A received optical signal may arrive at the first optical splitting system, and the first optical splitting system sends the received optical signal to a receiving system. In FIG. 1B, an optical signal sent by a laser is collimated by a collimation system, to regulate a propagation direction of the optical signal, so that the optical signal is propagated forward as much as possible. The collimation system may emit the optical signal into space. A received optical signal may arrive at a receiving system. It can be learned that, for the transceiver off-axis structure, because the optical signal sent by the optical module and the optical signal received by the optical module pass through different paths, there is no need to dispose a first optical splitting system.

In embodiments of this application, unless otherwise specified, a quantity of nouns represents “a singular noun or a plural noun”, namely, “one or more”. “At least one” means one or more, and “a plurality of” means two or more. “And/Or” is an association relationship for describing associated objects, and indicates that three relationships may exist. For example, A and/or B may indicate the following cases: only A exists, both A and B exist, and only B exists, where A and B may be in a singular form or a plural form. Unless otherwise specified, the character “/” generally indicates an “or” relationship between the associated objects. For example, A/B indicates A or B. “At least one of the following items (pieces)” or a similar expression thereof means any combination of these items, including any combination of singular items (pieces) or plural items (pieces). For example, at least one item (piece) of a, b, or c may indicate: a, b, c, a and b, a and c, b and c, or a, b, and c, where a, b, and c may be singular or plural.

In embodiments of this application, ordinal numbers such as “first” and “second” are used to distinguish between a plurality of objects, and not intended to limit sizes, content, a sequence, a time sequence, an application scenario, a priority, or an importance of the plurality of objects. For example, a first optical splitting system and a second optical splitting system may be a same optical splitting system, or may be different optical splitting systems. In addition, this name does not indicate that the two optical splitting systems have different structures, positions, priorities, application scenarios, or importance degrees.

The foregoing describes some concepts in embodiments of this application, and the following describes technical features in embodiments of this application.

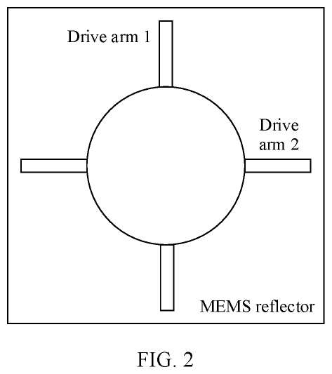

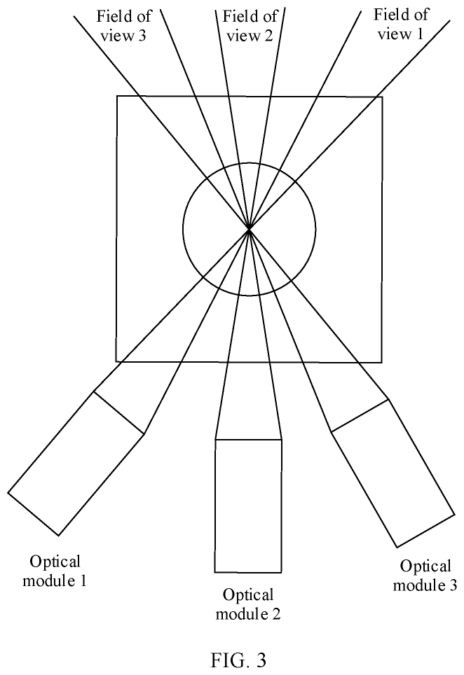

FIG. 2 is a schematic diagram of a MEMS reflector. The MEMS reflector is disposed on a chip, and two drive arms are further disposed on the chip. When the MEMS reflector works, the MEMS micromirror may be rotated on a two-dimensional plane by using the two drive arms to adjust a mechanical rotation angle of the MEMS reflector, so that a field of view of an optical signal reflected by the MEMS reflector can be changed. When the MEMS reflector is used as a scanning component of a solid-state lidar, the MEMS reflector cannot rotate at a large angle due to limited stability of the MEMS reflector. Therefore, to implement scanning of a large field of view, a plurality of optical modules may be used. For this, refer to FIG. 3. All the plurality of optical modules perform reflection by using the MEMS reflector, and each optical module may detect a specific field of view, so that the plurality of optical modules may detect a large field of view through splicing.

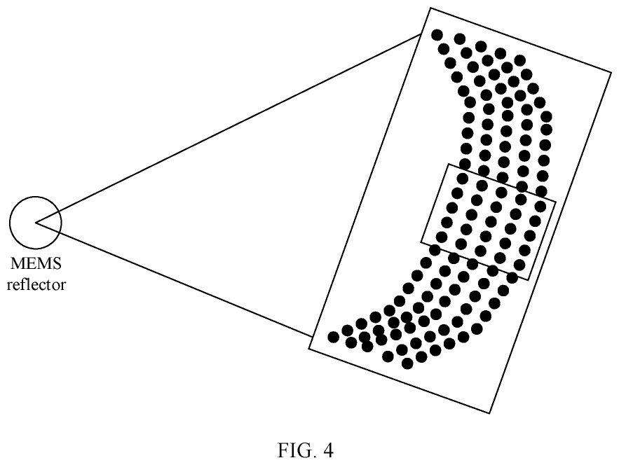

As a quantity of optical modules increases, a spliced field of view is larger. However, because the plurality of optical modules is reflected by using one MEMS reflector, a distortion of a splicing point cloud is larger. A point cloud may be a set of massive points that express target spatial distribution and a target surface feature in a same spatial reference system. For example, the point cloud in this embodiment of this application may be understood as a set of massive points included in light reflected by the MEMS reflector, and the point cloud can represent spatial distribution and a surface feature of a target object in space. The splicing point cloud in this embodiment of this application is a set of massive points obtained through reflection by the plurality of optical modules by using the MEMS reflector. For example, refer to FIG. 4. A plurality of points in FIG. 4 represent a splicing point cloud, and an area in a middle small box in the splicing point cloud is a central field of view. FIG. 4 shows only two optical paths reflected by the MEMS reflector. However, actually, a larger quantity of optical modules indicates more optical paths reflected by the MEMS reflector. FIG. 4 is merely an example. It can be learned that a direction of a point cloud included in the central field of view is inconsistent with a direction of a point cloud included in an edge field of view, and a larger deviation from the central field of view indicates a larger difference in a direction of a point cloud. In other words, a larger deviation from the center field of view indicates a greater distortion of a point cloud. A reason why this disadvantage occurs is that a plane formed by a normal line and reflected light of incident light of an optical module at an edge is not parallel to a rotation axis of the MEMS reflector. When the MEMS reflector rotates around the rotation axis, a spatial area scanned by emergent light corresponding to the optical module at the edge is not a rectangle, but a rhombus. In addition, a larger quantity of spliced optical modules indicates a larger distortion amount of a point cloud that is farther away from the center field of view.

Therefore, the technical solutions in embodiments of this application are provided. Embodiments of this application provide a detection apparatus. M micro reflectors are disposed in the detection apparatus, and M is an integer greater than or equal to 2. Therefore, when the detection apparatus includes a plurality of transceiver modules, the plurality of transceiver modules does not need to receive and send signals by using one micro reflector, but may receive and send signals by using the M micro reflectors. In this way, a distortion degree of a point cloud formed by optical signals reflected by the micro reflectors is reduced, and accuracy of optical signals received and sent by the detection apparatus is improved. In addition, because the plurality of micro reflectors is disposed, and each micro reflector may correspond to a corresponding transceiver module, a quantity of transceiver modules may accordingly be increased, so that a larger field of view can be obtained through splicing by using more transceiver modules. In this way, the detection apparatus can detect a larger field of view.

The detection apparatus may be an independent device, or the detection apparatus may be disposed in another device. The other device is, for example, a terminal device or a network device. The network device includes, for example, an access network device. The access network device is, for example, a base station. Alternatively, the other device may be a device like a radar. The detection apparatus in embodiments of this application may be installed in devices such as a motor vehicle, an unmanned aerial vehicle, a rail car, a bicycle, a signal light, a speed measurement apparatus, or a network device (for example, a base station or a terminal device in various systems). Embodiments of this application are applicable to detection between vehicles, detection between a vehicle and another apparatus like an unmanned aerial vehicle, or detection between other apparatuses. For example, the detection apparatus may be installed on an intelligent terminal like an intelligent transportation device, a smart home device, or a robot. A type of a terminal device on which the detection apparatus is installed, an installation position of the detection apparatus, a function of the detection apparatus, and the like are not limited in embodiments of this application.

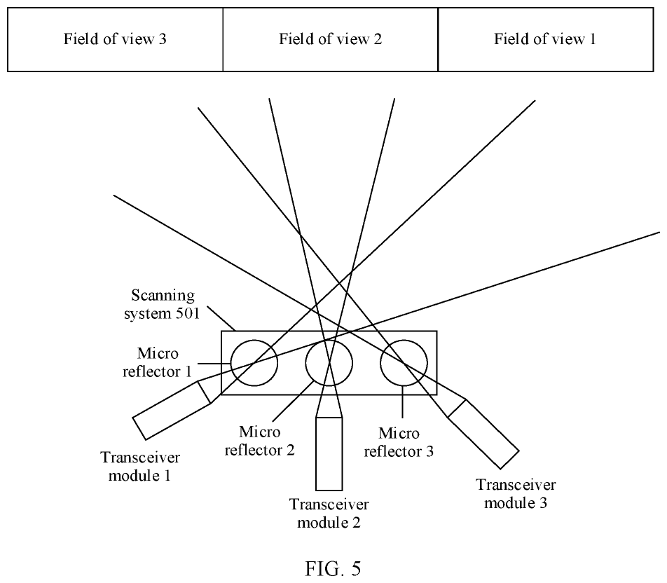

FIG. 5 is a schematic diagram of a detection apparatus according to an embodiment of this application. The detection apparatus may include a scanning system 501 and a transceiver module (or an optical module). For a structure of the transceiver module, refer to the structure of the optical module shown in FIG. 1A or FIG. 1B. The scanning system 501 may include a micro reflector array. The micro reflector array may include M micro reflectors. As shown in FIG. 5, one circle represents one micro reflector. The micro reflector array may be located on one chip (or referred to as a wafer), or may be located on a plurality of chips. For example, the M micro reflectors are separately located on M chips, and one micro reflector is disposed on each chip. M is an integer greater than or equal to 2. In other words, the detection apparatus may include two, three, or more micro reflectors. FIG. 5 shows three micro reflectors: a micro reflector 1, a micro reflector 2, and a micro reflector 3. However, a quantity of micro reflectors is not limited in this embodiment of this application. A quantity of transceiver modules included in the detection apparatus is P, and P is an integer less than or equal to M. For example, FIG. 5 shows three transceiver modules: a transceiver module 1, a transceiver module 2, and a transceiver module 3. However, a quantity of transceiver modules is not limited in this embodiment of this application. For example, P may be equal to M. In this case, the transceiver modules are in a one-to-one correspondence with the micro reflectors. Alternatively, P may be less than M. In this case, one micro reflector may correspond to one or more transceiver modules. If optical signals received and sent by a transceiver module is reflected by a micro reflector, the transceiver module corresponds to the micro reflector. After arriving at space, an optical signal sent by a transceiver module may cover a specific field of view. In other words, the transceiver module may detect the specific field of view. For example, in FIG. 5, a field of view 1 is a field of view detected by the transceiver module 1, a field of view 2 is a field of view detected by the transceiver module 2, and a field of view 3 is a field of view detected by the transceiver module 3. It can be learned that the field of view 1, the field of view 2, and the field of view 3 can be spliced into a larger field of view. In other words, fields of view of the transceiver modules included in the detection apparatus may be spliced, to obtain a larger field of view. It should be noted that, in embodiments of this application, the “space” is “external space”, namely, space outside the detection apparatus.

In FIG. 5, P=M is used as an example. In other words, the transceiver modules are in a one-to-one correspondence with the micro reflectors. For example, optical signals received and sent by the transceiver module 1 are reflected by the micro reflector 1, optical signals received and sent by the transceiver module 2 are reflected by the micro reflector 2, and optical signals received and sent by the transceiver module 3 are reflected by the micro reflector 3. In this structure, optical signals received and sent by different transceiver modules are reflected by different micro reflectors. Therefore, a power loss of an optical signal sent by each transceiver module is small, so that detection of each transceiver module is more accurate.

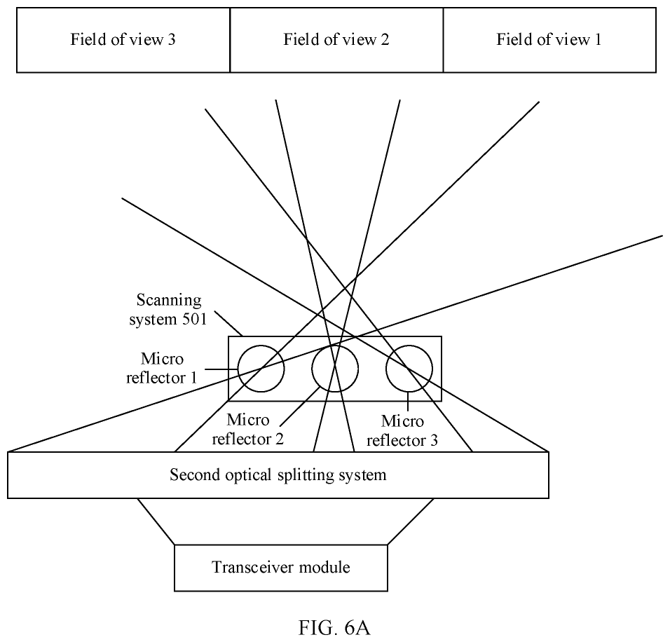

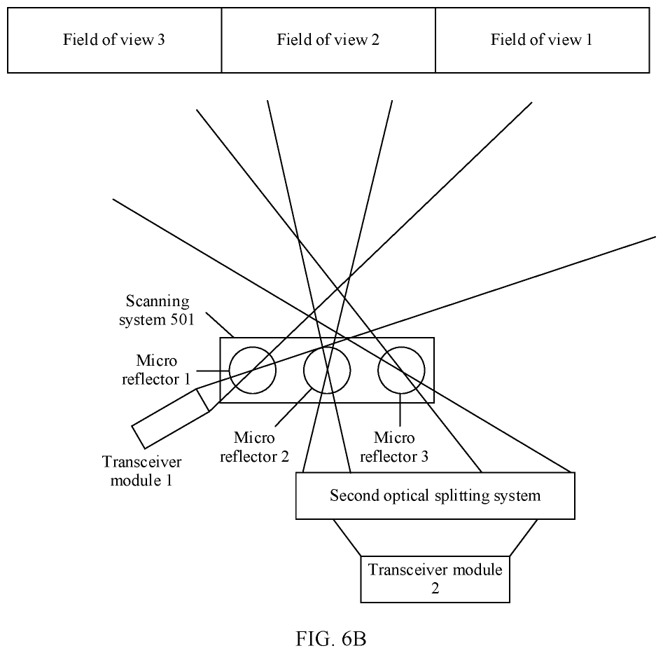

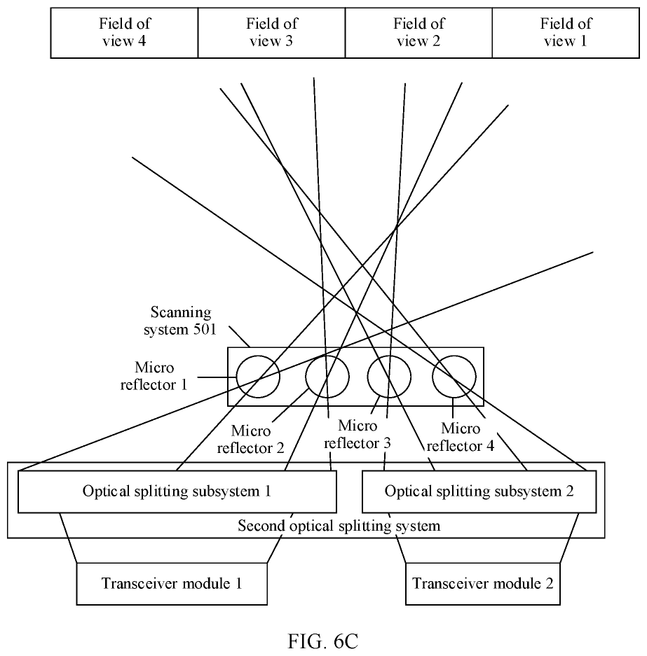

Alternatively, P may be less than M. For example, P=1. For this, refer to FIG. 6A. In this case, the detection apparatus includes one transceiver module. An optical signal sent by the transceiver module may arrive at the M micro reflectors, and is reflected by the M micro reflectors to space. A signal from space may also be reflected by the M micro reflectors to the transceiver module. In FIG. 6A, M=3 is used as an example.

For another example, if P is greater than 1, but P is less than M, the detection apparatus may include a plurality of transceiver modules, one of the transceiver modules may correspond to one or more of the M micro reflectors, and the plurality of transceiver modules correspond to the M micro reflectors in total. If P is less than M, a quantity of transceiver modules included in the detection apparatus may be reduced, to reduce a size of the detection apparatus and reduce costs of the detection apparatus. For example, in the plurality of transceiver modules, a transceiver module corresponds to one of the M micro reflectors, and another transceiver module corresponds to a plurality of micro reflectors in the M micro reflectors. For example, refer to FIG. 6B. P=2 and M=3 are used as an example. In the two transceiver modules, a transceiver module 1 corresponds to a micro reflector 1, and a transceiver module 2 corresponds to a micro reflector 2 and a micro reflector 3. For another example, each of the plurality of transceiver modules corresponds to a plurality of micro reflectors in the M micro reflectors. Refer to FIG. 6C. P=2 and M=4 are used as an example. In the two transceiver modules, a transceiver module 1 corresponds to a micro reflector 1 and a micro reflector 2, and a transceiver module 2 corresponds to a micro reflector 3 and a micro reflector 4.

A transceiver module and a micro reflector corresponding to the transceiver module may form a detection channel, or referred to as a measurement channel, or the like. If one transceiver module corresponds to a plurality of micro reflectors, the transceiver module and each of the plurality of micro reflectors may form one detection channel. In other words, a plurality of detection channels may be formed between the transceiver module and the plurality of micro reflectors. One detection channel may be used to detect one field of view.

In this embodiment of this application, the plurality of micro reflectors is disposed, so that different transceiver modules may correspond to different micro reflectors, and all the transceiver modules do not need to correspond to one micro reflector, thereby reducing a distortion of a point cloud formed in space by optical signals sent by the transceiver modules, and improving detection accuracy of the detection apparatus. In addition, because there is a large quantity of micro reflectors, a quantity of transceiver modules may also be correspondingly increased, so that a larger field of view can be obtained through splicing. Therefore, detection of the larger field of view can be implemented.

Because the plurality of micro reflectors is disposed, each micro reflector may correspond to a corresponding transceiver module, and all the transceiver modules do not need to correspond to one micro reflector, the quantity of transceiver modules may be increased, so that a larger field of view can be obtained through splicing by using more transceiver modules. In this way, the detection apparatus can detect a larger field of view.

In addition, because the plurality of micro reflectors is disposed, and each micro reflector may correspond to the corresponding transceiver module, when a rotation angle of a micro reflector is adjusted, a scanning angle of an optical signal reflected by the micro reflector in space can be changed, that is, an angle of view of a transceiver module corresponding to the micro reflector in space can be changed. In this way, a size of a field of view of the transceiver module corresponding to the micro reflector in space can be adjusted. For example, for FIG. 5, to focus on some target objects in the field of view 2, a rotation angle of the micro reflector 2 corresponding to the field of view 2 may be adjusted to reduce the angle of view of the field of view 2, so as to reduce the field of view 2. In this way, detection of some target objects can be more flexibly. After the field of view 2 is reduced, there may be a gap between the field of view 2 and another field of view (for example, the field of view 1 and/or the field of view 3). Therefore, a rotation angle of the micro reflector 1 corresponding to the field of view 1 may be adjusted to increase a size of the field of view 1, and/or a rotation angle of the micro reflector 3 corresponding to the field of view 3 may be adjusted to increase a size of the field of view 3. For example, the sizes of the field of view 1 and the field of view 3 are increased, so that the field of view 1 and the field of view 3 can cover a reduced area of the field of view 2, to better implement seamless splicing between the fields of view, and improve detection coverage of the detection apparatus. For another example, for FIG. 5, to expand a range of a central field of view, so as to detect more target objects in the central field of view, a rotation angle of the micro reflector 2 corresponding to the field of view 2 may be adjusted to increase an angle of view of the field of view 2, so as to increase the field of view 2. After the field of view 2 is increased, there may be an overlapping area between the field of view 2 and another field of view (for example, the field of view 1 and/or the field of view 3). For the overlapping area, the detection apparatus may repeatedly perform detection, and detection resources are wasted. Therefore, a rotation angle of the micro reflector 1 corresponding to the field of view 1 may be adjusted to reduce a size of the field of view 1 (or change a position of the field of view 1), and/or a rotation angle of the micro reflector 3 corresponding to the field of view 3 may be adjusted to reduce a size of the field of view 3 (or change a position of the field of view 1). For example, the sizes of the field of view 1 and the field of view 3 are reduced, or the positions of the field of view 1 and the field of view 3 are changed, so that seamless splicing can be implemented between the field of view 1, the field of view 2, and the field of view 3, an overlapping area can be reduced, and detection resources can be reduced. In addition, if the positions of the field of view 1 and/or the field of view 3 are/is changed, the field of view 1 or the field of view 3 can cover an area that is not previously covered, so that the detection apparatus can detect a larger range.

It should be noted that a portion or all of the P transceiver modules each may further include a reflector, and the reflector is a reflector that may be optionally included in the transceiver module, instead of a micro reflector included in the micro reflector array in this embodiment of this application. For example, the transceiver module is in a transmitting-receiving coaxial structure. An optical signal sent by a laser of the transceiver module is collimated by a collimation system and enters a first optical splitting system for optical splitting. An optical signal obtained through optical splitting is incident to the reflector included in the transceiver module. After the optical signal arrives at the reflector, the reflector may reflect the optical signal to a micro reflector corresponding to the transceiver module in the micro reflector array, and then the micro reflector reflects the optical signal.

It can be learned from the foregoing description that, when P is less than M, an optical signal sent by each of the portion or all of the P transceiver modules needs to reach a plurality of micro reflectors, and each transceiver module also needs to receive signals reflected by the plurality of micro reflectors. Therefore, optionally, when P is less than M, the detection apparatus may further include a second optical splitting system. For example, the second optical splitting system may split H optical signals sent by H transceiver modules in the P transceiver modules into K optical signals, so that the K optical signals arrive at K micro reflectors in the M micro reflectors, and P−H optical signals sent by P−H transceiver modules in the P transceiver modules may directly arrive at K−M micro reflectors without passing through the optical splitting system. For example, P−H=K−M. In an example, P−H transceiver modules may be in a one-to-one correspondence with K−M micro reflectors. K is an integer greater than or equal to 2 and less than or equal to M. It may be understood that the K micro reflectors are a portion or all of the M micro reflectors. H is an integer greater than or equal to 1 and less than or equal to P. It may be understood that the H transceiver modules are a portion or all of the P transceiver modules. The H optical signals are optical signals sent by the H transceiver modules in the P transceiver modules. The second optical splitting system may also combine K optical signals that are from space and reflected by the K micro reflectors into H optical signals, so that the H optical signals arrive at the H transceiver modules. In an example, the second optical splitting system may perform optical splitting on the H transceiver modules, and the split optical signals may arrive at the K micro reflectors. In this case, the optical signals received by the K micro reflectors also arrive at the second optical splitting system, are combined by the second optical splitting system into the H optical signals, and enter the H transceiver modules. For example, H is greater than 1. In this case, the second optical splitting system may perform optical splitting on each of the H transceiver modules. For example, for a transceiver module A, the second optical splitting system may split an optical signal sent by the transceiver module A into at least two optical signals, and the at least two optical signals arrive at at least two micro reflectors. In addition, optical signals (where the optical signals are at least two echoes corresponding to the at least two optical signals) that are from space and received by the at least two micro reflectors also arrive at the second optical splitting system, and the second optical splitting system combines the at least two echoes into one optical signal, and sends the optical signal to the transceiver module A.

It should be noted that, as described above, if the transceiver module uses the transmitting-receiving coaxial structure, the transceiver module also includes the first optical splitting system. The first optical splitting system is included in the transceiver module, but the second optical splitting system does not belong to the transceiver module. Internal structures of the first optical splitting system and the second optical splitting system may be the same or different. The “first” and the “second” do not indicate that the internal structures or other aspects of the two optical splitting systems are different, but are merely intended to indicate that the two optical splitting systems are disposed at different locations.

In the detection apparatus, if P is greater than 1, and each of the at least two transceiver modules corresponds to two or more micro reflectors, optionally, an optical splitting subsystem may be disposed for each of the at least two transceiver modules, and the second optical splitting system includes at least two optical splitting subsystems disposed for the at least two transceiver modules. If P=1, and the transceiver module corresponds to two or more micro reflectors, an optical splitting system may also be disposed for the transceiver module. In this case, only one optical splitting system needs to be disposed in the detection apparatus. Therefore, the optical splitting system is the second optical splitting system, and is not considered as an optical splitting subsystem.

FIG. 6A, FIG. 6B, and FIG. 6C each include a second optical splitting system. If each of the P transceiver modules corresponds to two or more micro reflectors, an optical splitting subsystem may be disposed for each of the P transceiver modules. In this case, the second optical splitting system corresponds to all of the P transceiver modules, for example, as shown in FIG. 6A or FIG. 6C. In this case, it may be considered that the second optical splitting system splits P optical signals sent by the P transceiver modules into M optical signals, and then sends the M optical signals to the M micro reflectors, or may split M optical signals that are from space and reflected by the M micro reflectors into P optical signals, and then send the P optical signals to the P transceiver modules. Alternatively, if each of only a portion of the P transceiver modules (for example, H transceiver modules, where H is less than P in this case) corresponds to two or more micro reflectors, an optical splitting subsystem may be disposed for each of the H transceiver modules, and no optical splitting subsystem needs to be disposed for P−H transceiver modules. In this case, the second optical splitting system corresponds to the H transceiver modules in the P transceiver modules, for example, as shown in FIG. 6B. In this case, it may be considered that the second optical splitting system splits optical signals sent by the H transceiver modules in the P transceiver modules into K optical signals, and then sends the K optical signals to K micro reflectors, or may combine K optical signals that are from space and reflected by the K micro reflectors into H optical signals, and then send the H optical signals to the H transceiver modules. H is a positive integer less than or equal to P, and K is a positive integer less than or equal to M.

For example, the second optical splitting system in FIG. 6A corresponds to three micro reflectors in FIG. 6A. The second optical splitting system may split an optical signal sent by the transceiver module into three optical signals, and then send the three optical signals to the three micro reflectors respectively, or may combine three optical signals that are from space and reflected by the three micro reflectors into one optical signal, and then send the optical signal to the transceiver module.

For another example, in FIG. 6B, a transceiver module 1 corresponds to a micro reflector 1, and a transceiver module 2 corresponds to a micro reflector 2 and a micro reflector 3. Therefore, the second optical splitting system needs to be disposed only for the transceiver module 2, and the second optical splitting system corresponds to the micro reflector 2 and the micro reflector 3. The second optical splitting system may split an optical signal sent by the transceiver module 2 into two optical signals, and then send the two optical signals to the micro reflector 2 and the micro reflector 3 respectively, or may combine two optical signals that are from space and reflected by the micro reflector 2 and the micro reflector 3 into one optical signal, and then send the optical signal to the transceiver module 2.

For another example, in FIG. 6C, a transceiver module 1 corresponds to a micro reflector 1 and a micro reflector 2, and a transceiver module 2 corresponds to a micro reflector 3 and a micro reflector 4. Therefore, an optical splitting subsystem 1 may be disposed for the transceiver module 1, and an optical splitting subsystem 2 may be disposed for the transceiver module 2. In this case, the second optical splitting system in FIG. 6B also includes two optical splitting subsystems, where the optical splitting subsystem 1 corresponds to the micro reflector 1 and the micro reflector 2, and the optical splitting subsystem 2 corresponds to the micro reflector 3 and the micro reflector 4. The optical splitting subsystem 1 may split an optical signal sent by the transceiver module 1 into two optical signals, and then send the two optical signals to the micro reflector 1 and the micro reflector 2 respectively, or may combine two optical signals that are from space and reflected by the micro reflector 1 and the micro reflector 2 into one optical signal, and then send the optical signal to the transceiver module 1. The optical splitting subsystem 2 may split an optical signal sent by the transceiver module 2 into two optical signals, and then send the two optical signals to the micro reflector 3 and the micro reflector 4 respectively, or may combine two optical signals that are from space and reflected by the micro reflector 3 and the micro reflector 4 into one optical signal, and then send the optical signal to the transceiver module 2.

In conclusion, when P is less than M, the second optical splitting system is disposed, so that signals received and sent by the P transceiver modules can still be reflected by the M micro reflectors, and the P transceiver modules and the M micro reflectors can work normally.

A transceiver module can detect a specific field of view. However, because a diameter of the micro reflector is small, for example, the diameter of the micro reflector is generally at a nanometer level, a receiving aperture of the micro reflector is small, and energy of a received optical signal is small. Consequently, a detection distance of the transceiver module is limited. According to this embodiment of this application, a beam expansion system may be disposed for a transceiver module whose detection distance needs to be extended. The beam expansion system may be disposed at a front end of a micro reflector. After being reflected by the micro reflector, an optical signal sent by the transceiver module may enter the beam expansion system, to be transmitted to space through the beam expansion system. A signal from space enters the beam expansion system, arrives at the micro reflector after passing through the beam expansion system, and may be reflected to the transceiver module by the micro reflector. If a beam expansion system is disposed for a transceiver module, it is equivalent to increasing a receiving aperture of a detection channel corresponding to the transceiver module, so that energy of an optical signal received by the transceiver module can be increased. In this way, a detection distance of the transceiver module can be increased. Increasing the detection distance is equivalent to expanding a detection range of the transceiver module. Therefore, a beam expansion system may be disposed for a transceiver module that needs to perform long-distance detection, and a beam expansion system may not be disposed for a transceiver module that needs to perform short-distance detection, so that the detection apparatus can implement detection at different distances, thereby improving detection flexibility.

Optionally, the detection apparatus may include N beam expansion systems, the N beam expansion systems may correspond to a portion or all of the M micro reflectors, and N is a positive integer less than or equal to M. One beam expansion system may correspond to one or more micro reflectors. That one micro reflector corresponds to one beam expansion system may be understood as follows. After being reflected by the micro reflector, an optical signal sent by a transceiver module may enter the beam expansion system, and be transmitted to space through the beam expansion system. A signal from space enters the beam expansion system, arrives at the micro reflector after passing through the beam expansion system, and may be reflected by the micro reflector to the transceiver module. Further, one or more of the N beam expansion systems are, for example, zoom beam expansion systems. The so-called zoom beam expansion system is a beam expansion system that can change a focal length. The focal length is changed, so that a size of a field of view corresponding to the zoom beam expansion system can be adjusted. This adjustment is also equivalent to expanding a detection range of the detection apparatus. In other words, one or more beam expansion systems in this embodiment of this application may be zoom beam expansion systems. Through the zoom beam expansion system, not only a detection distance can be increased, but also a size of a detected field of view can be adjusted. It may be understood that not only a detection depth can be increased, but also a detection width can be adjusted, so that the detection range can be expanded in a plurality of dimensions. For example, each of the N beam expansion systems is a zoom beam expansion system, the N zoom beam expansion systems correspond to a portion or all of the M micro reflectors, and correspondingly, the N zoom beam expansion systems correspond to a portion or all of the P transceiver modules. Therefore, optical signals sent by the portion or all of the P transceiver modules arrive at the N zoom beam expansion systems through the portion or all of the M micro reflectors, and the portion or all of the P transceiver modules receive optical signals that arrive at the portion or all of the M micro reflectors through the N zoom beam expansion systems and then are reflected by the portion or all of the M micro reflectors.

Optionally, the central field of view is usually a key field of view for detection. For the central field of view, long-distance detection may be required. Therefore, a zoom beam expansion system may be disposed at a front end of a micro reflector corresponding to the central field of view. For example, the N zoom beam expansion systems include a first zoom beam expansion system, and an optical signal sent by a first transceiver module in the P transceiver modules arrives at the first zoom beam expansion system through a first micro reflector, and/or the first transceiver module receives an optical signal that arrives at the first micro reflector through the first zoom beam expansion system and then is reflected by the first micro reflector. The first micro reflector is one of the M micro reflectors. For example, the first reflector may be located in a middle position of the M micro reflectors. In other words, the zoom beam expansion system is disposed at the front end of the micro reflector corresponding to the central field of view, so that a detection range of the central field of view can be expanded or narrowed.

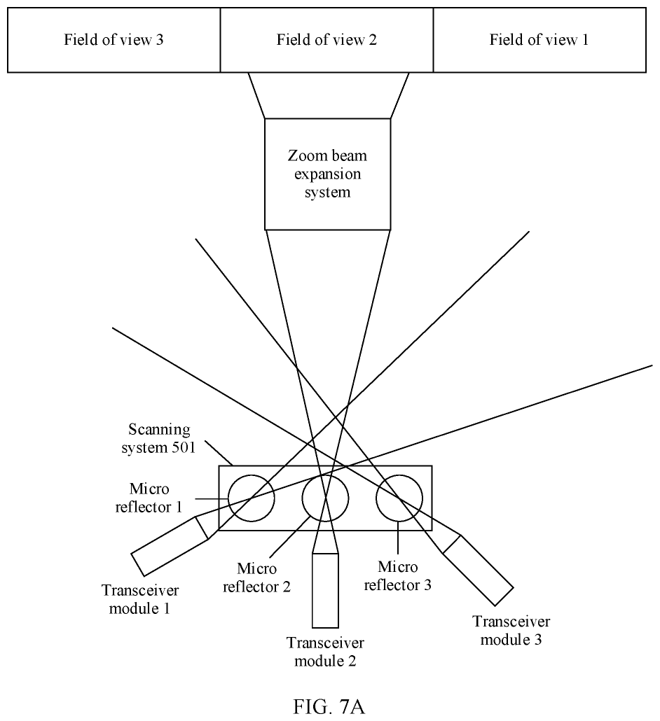

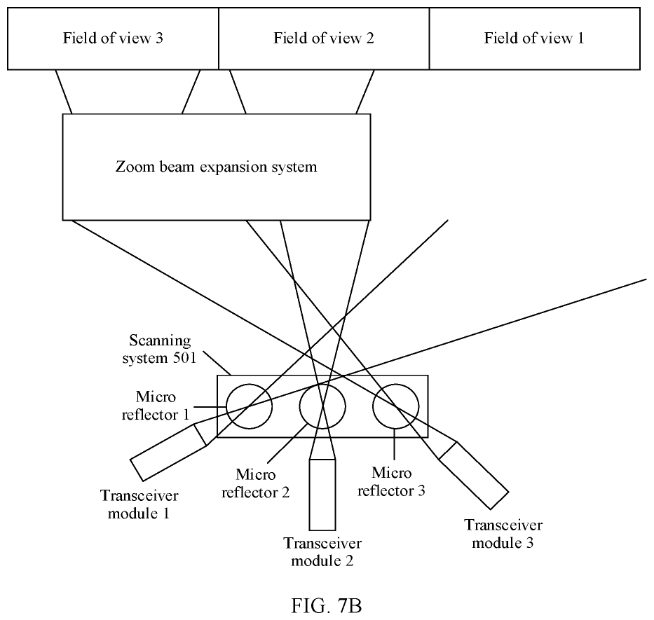

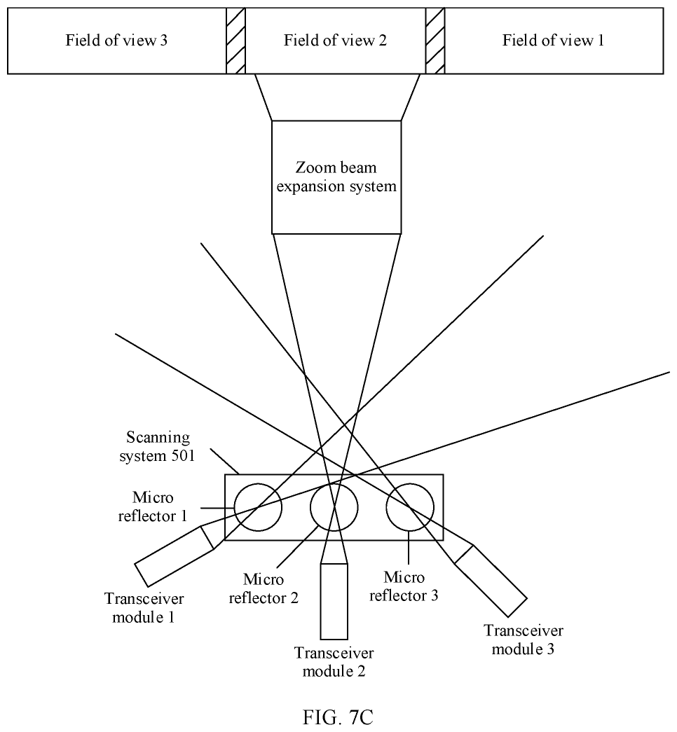

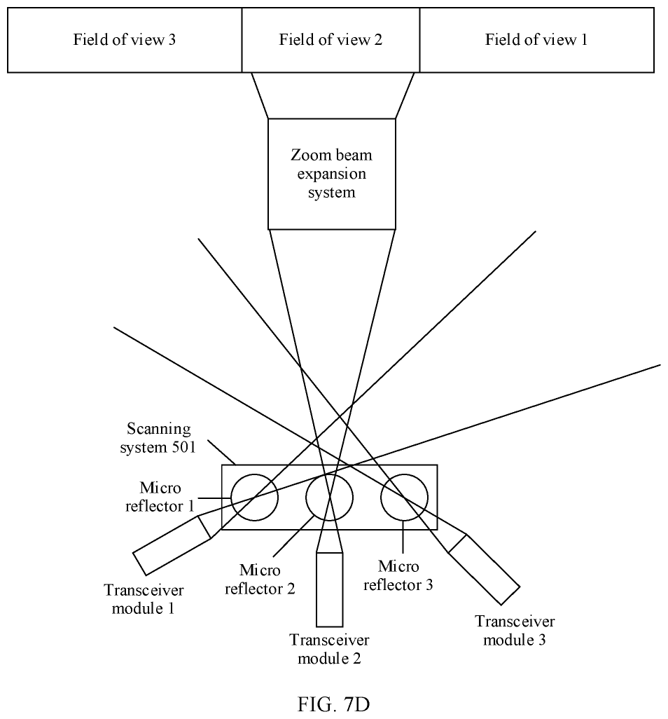

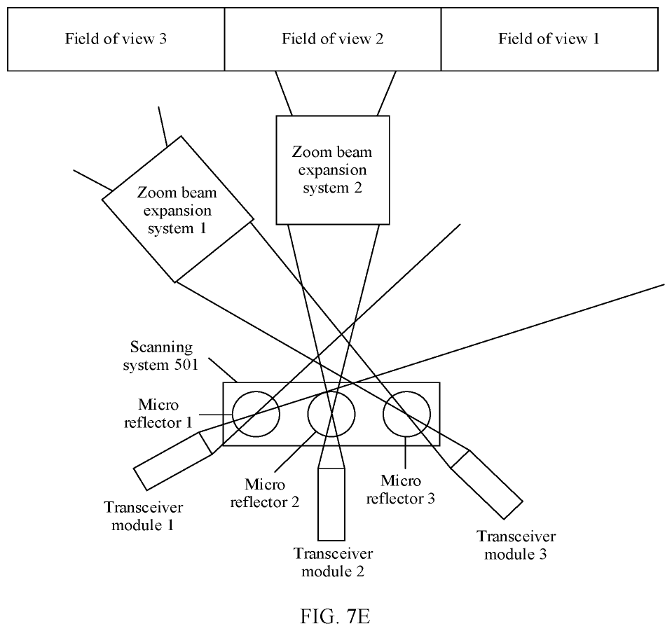

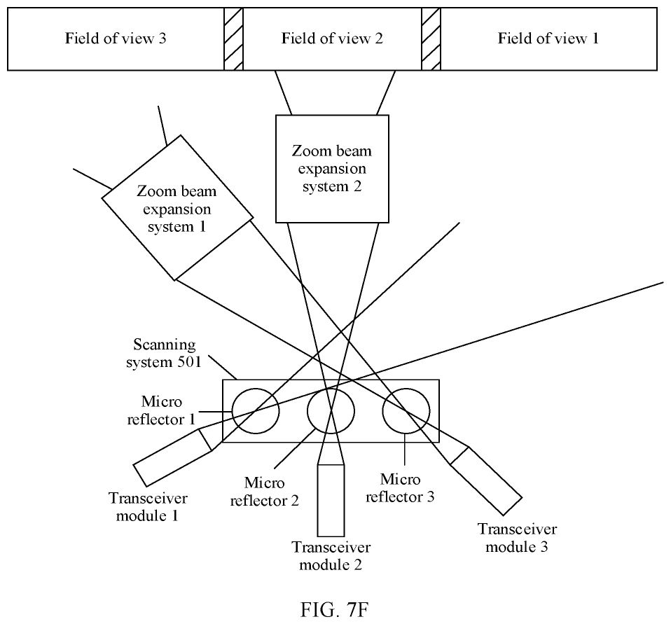

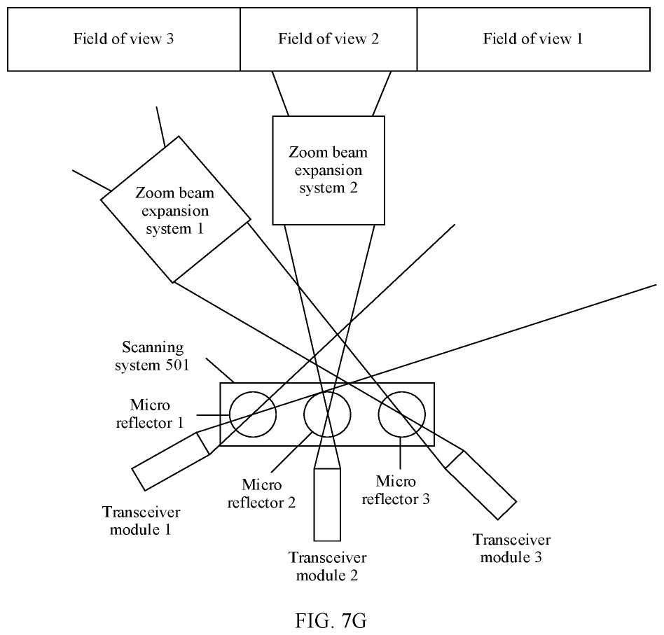

For example, FIG. 7A is a schematic diagram of a detection apparatus including a zoom beam expansion system. In FIG. 7A, N=1, the zoom beam expansion system is disposed at a front end of a micro reflector 2 corresponding to a transceiver module 2, and the transceiver module 2 detects a central field of view. The zoom beam expansion system may be disposed at the front end of the micro reflector 2 corresponding to the central field of view. The zoom beam expansion system is the first zoom beam expansion system, the transceiver module 2 may be referred to as the first transceiver module, and the micro reflector 2 may be referred to as the first micro reflector. An optical signal sent by the transceiver module 2 arrives at the zoom beam expansion system after being reflected by the micro reflector 2, and enters space through the zoom beam expansion system. An optical signal from space arrives at the micro reflector 2 after entering the zoom beam expansion system, and arrives at the transceiver module 2 after being reflected by the micro reflector 2. No zoom beam expansion system is disposed at a front end of a micro reflector 1 corresponding to a transceiver module 1. Therefore, an optical signal sent by the transceiver module 1 is reflected to space by the micro reflector 1, and an optical signal from space arrives at the transceiver module 1 after being reflected by the micro reflector 1. An optical signal transmission process of a transceiver module 3 is also the same as that of the transceiver module 1, and details are not described again. Through the zoom beam expansion system, long-distance measurement can be performed in the central field of view. However, neither the transceiver module 1 nor the transceiver module 3 detects the central field of view. For these fields of view, there may be no requirement for long-distance measurement. Therefore, no zoom beam expansion system may be disposed for the micro reflector 1 and the micro reflector 3, to reduce a size of the detection apparatus.

In FIG. 7A, the zoom beam expansion system is disposed at a front end of one micro reflector. In other words, one zoom beam expansion system corresponds to one micro reflector. Alternatively, one zoom beam expansion system may correspond to a plurality of micro reflectors. For example, FIG. 7B is another schematic diagram of a detection apparatus including a zoom beam expansion system. In FIG. 7B, N=1, and the zoom beam expansion system is disposed at a front end of a micro reflector 2 corresponding to a transceiver module 2 and a front end of a micro reflector 3 corresponding to a transceiver module 3. In FIG. 7B, an optical signal sent by the transceiver module 2 arrives at the zoom beam expansion system after being reflected by the micro reflector 2, and enters space through the zoom beam expansion system. An optical signal from space arrives at the micro reflector 2 after entering the zoom beam expansion system, and arrives at the transceiver module 2 after being reflected by the micro reflector 2. An optical signal transmission process of the transceiver module 3 is also the same as that of the transceiver module 2, and details are not described again. However, no zoom beam expansion system is disposed at a front end of a micro reflector 1 corresponding to a transceiver module 1. Therefore, an optical signal sent by the transceiver module 1 is reflected to space by the micro reflector 1, and an optical signal from space arrives at the transceiver module 1 after being reflected by the micro reflector 1. In this embodiment of this application, the zoom beam expansion system may be flexibly set. A zoom beam expansion system may be disposed at a front end of each micro reflector corresponding to a field of view that requires long-distance detection. For example, zoom beam expansion systems need to be disposed for adjacent micro reflectors. In this case, a zoom beam expansion system may be disposed for each of the micro reflectors, so that a detection process is more flexible. Alternatively, a same zoom beam expansion system may be disposed for the micro reflectors (as shown in FIG. 7B), to reduce a quantity of zoom beam expansion systems, thereby reducing a size of the detection apparatus.

In this embodiment of this application, a size of a field of view detected by a transceiver module is not fixed, but may be flexibly adjusted. For example, if a zoom beam expansion system is disposed at a front end of a micro reflector, and a size of a field of view detected by a transceiver module corresponding to the micro reflector needs to be adjusted, a focal length of the zoom beam expansion system and/or a rotation angle of the micro reflector may be adjusted to adjust an angle of view of the field of view, so as to adjust the field of view. However, if no zoom beam expansion system is disposed at a front end of a micro reflector, and a size of a field of view detected by a transceiver module corresponding to the micro reflector needs to be adjusted, a rotation angle of the micro reflector may be adjusted to adjust an angle of view of the field of view, so as to adjust the field of view. The size of the field of view detected by the transceiver module is adjusted, so that fields of view detected by the plurality of transceiver modules can be better spliced, a blind area between the fields of view is reduced, and space detection coverage is improved.

For example, at a moment, for a size of a field of view detected by each transceiver module, refer to FIG. 7A. It can be learned that a field of view 1 of the transceiver module 1, a field of view 2 of the transceiver module 2, and a field of view 3 of the transceiver module 3 not only exist as independent fields of view, but also form a larger field of view through splicing. Then, to detect a target object of interest in the central field of view, the central field of view needs to be reduced. The central field of view may be reduced by reducing an angle of view of the central field of view. The angle of view of the central field of view is a scanning angle of the optical signal sent by the transceiver module 2 in space. For example, a focal length of the zoom beam expansion system in FIG. 7A may be adjusted to reduce the angle of view of the central field of view. FIG. 7C is a schematic diagram obtained after the angle of view of the central field of view is adjusted. A field of view 2 represents the central field of view, and an area drawn with “/” represents a reduction amount of the angle of view of the central field of view. In an example, before the angle of view of the central field of view is reduced, the central field of view includes the area drawn with “/”, and after the angle of view of the central field of view is reduced, the central field of view no longer includes the area drawn with “/”. In this case, if an angle of view of another transceiver module is not adjusted, the area drawn with “/” becomes a blind area between fields of view, and each transceiver module cannot detect the area. Therefore, an angle of view corresponding to at least one remaining transceiver module in the P transceiver modules other than the transceiver module corresponding to the central field of view may be adjusted, to reduce a blind area between fields of view of the P transceiver modules as much as possible.

FIG. 7C is used as an example. To reduce the blind area between the fields of view, an angle of view of a field of view 1 corresponding to a transceiver module 1 and/or an angle of view of a field of view 3 corresponding to a transceiver module 3 may be adjusted. The angle of view of the field of view 1 may be a scanning angle of an optical signal sent by the transceiver module 1 in space, and the angle of view of the field of view 3 may be a scanning angle of an optical signal sent by the transceiver module 3 in space. For example, the angle of view of the field of view 1 is adjusted and the angle of view of the field of view 3 is adjusted, and FIG. 7D is a schematic diagram obtained after the adjustment. It can be learned that both the angle of view of the field of view 1 and the angle of view of the field of view 2 are expanded. Therefore, the area drawn with “/” in FIG. 7C is basically covered by the field of view 1 and the field of view 2 in FIG. 7D. In this way, the blind area between the fields of view is reduced, and space detection coverage of the detection apparatus is improved. Because no zoom beam expansion system is disposed in front of a micro reflector corresponding to the transceiver module 1, a scanning angle of an optical signal reflected by the micro reflector 1 in space may be changed by rotating the micro reflector 1, to adjust the angle of view of the field of view 1. An adjustment process is the same for the field of view 3.

For another example, at a moment, for a size of a field of view detected by each transceiver module, refer to FIG. 7E. A difference between FIG. 7E and FIG. 7A lies in that in FIG. 7E, two zoom beam expansion systems are disposed, where a zoom beam expansion system 1 is disposed at a front end of a micro reflector 3, and a zoom beam expansion system 2 is disposed at a front end of a micro reflector 2. Then, to detect a target object of interest in a central field of view, the central field of view needs to be reduced. The central field of view may be reduced by reducing an angle of view of the central field of view. The angle of view of the central field of view is a scanning angle of an optical signal sent by a transceiver module 2 in space. For example, a focal length of the zoom beam expansion system 2 in FIG. 7E may be adjusted to reduce the angle of view of the central field of view. FIG. 7F is a schematic diagram obtained after the angle of view of the central field of view is adjusted. Similarly, an area drawn with “/” represents a reduction amount of the angle of view of the central field of view.

FIG. 7F is used as an example. To reduce a blind area between fields of view, an angle of view of a field of view 1 corresponding to a transceiver module 1 and/or an angle of view of a field of view 3 corresponding to a transceiver module 3 may be adjusted. For example, the angle of view of the field of view 1 is adjusted and the angle of view of the field of view 3 is adjusted, and FIG. 7G is a schematic diagram obtained after the adjustment. It can be learned that both the angle of view of the field of view 1 and the angle of view of the field of view 3 are expanded. Therefore, the area drawn with “/” in FIG. 7F is basically covered by the field of view 1 and the field of view 3 in FIG. 7G. In this way, the blind area between the fields of view is reduced, and space detection coverage of the detection apparatus is improved. Because the zoom beam expansion system 1 is disposed in front of the micro reflector 3 corresponding to the transceiver module 3, the angle of view of the field of view 3 may be adjusted by adjusting the zoom beam expansion system 1, or a scanning angle of an optical signal reflected by the micro reflector 3 in space may be changed by rotating the micro reflector 3, to adjust the angle of view of the field of view 3. Because no zoom beam expansion system is disposed in front of a micro reflector 1 corresponding to the transceiver module 1, a scanning angle of an optical signal reflected by the micro reflector 1 in space may be changed by rotating the micro reflector 1, to adjust the angle of view of the field of view 1.

Optionally, the detection apparatus may further include a control unit. The control unit may be connected to the P transceiver modules and the M micro reflectors, to control the P transceiver modules to send optical signals, and adjust a rotation angle of one or more micro reflectors in the M micro reflectors. If the detection apparatus includes a zoom beam expansion system, the control unit may further be connected to the zoom beam expansion system, to indicate the zoom beam expansion system to adjust a focal length. For example, if the detection apparatus is a radar, the control unit may be implemented by a control chip in the radar. For another example, if the detection apparatus is a vehicle, the control unit may be implemented by a controller in the vehicle, or may be implemented by a device like a radar disposed in the vehicle.

Alternatively, the detection apparatus does not include a control unit, and the control unit and the detection apparatus are two independent entities. The control unit can be connected to the detection apparatus, to control the P transceiver modules to send optical signals, and adjust a rotation angle of one or more micro reflectors in the M micro reflectors. If the detection apparatus includes a zoom beam expansion system, the control unit may further indicate the zoom beam expansion system to adjust a focal length and the like. For example, if the detection apparatus is a functional module disposed in a radar, the control unit may be implemented by a control chip in the radar. For another example, if the detection apparatus is a functional module disposed in a vehicle, the control unit may be implemented by an in-vehicle controller, or may be implemented by a device like a radar disposed in the vehicle (in this case, the radar does not include the detection apparatus).

For another example, when the detection apparatus is a radar, and the control unit is implemented by an in-vehicle controller, the control unit sends a control signal to the detection apparatus, to adjust a rotation angle of one or more micro reflectors in the M micro reflectors, and/or control the P transceiver modules to send optical signals.

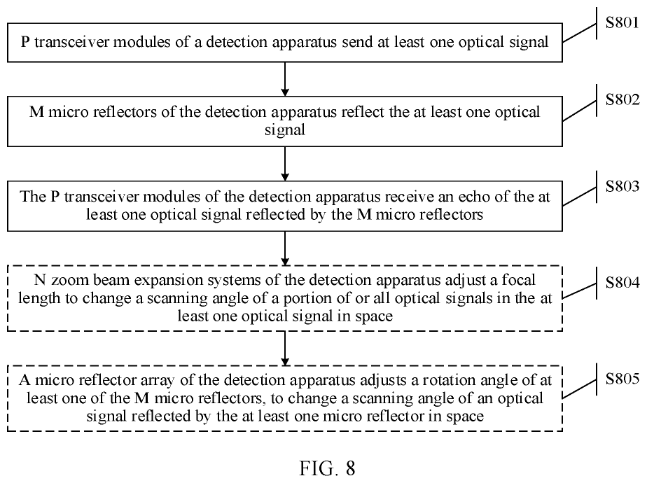

The foregoing describes the detection apparatus provided in embodiments of this application. The following describes the detection method described in embodiments of this application. The detection method may be performed by the detection apparatus. A working process of the detection apparatus can be more clearly described by using the following detection method. For content such as a structure of the detection apparatus in the following, refer to the foregoing descriptions. FIG. 8 is a procedure of a detection method according to an embodiment of this application.

S801: P transceiver modules send at least one optical signal.

In an application, the P transceiver modules may simultaneously send optical signals, or a portion of the P transceiver modules may send an optical signal, and a remaining transceiver module does not send an optical signal. In S801, that all the P transceiver modules send optical signals is used as an example. For example, the P transceiver modules may send at least one optical signal, and the at least one optical signal is, for example, P optical signals.

S802: M micro reflectors reflect the at least one optical signal.

If the detection apparatus includes no second optical splitting system, the at least one optical signal sent by the P transceiver modules may directly arrive at the M micro reflectors, and the M micro reflectors may reflect the at least one optical signal. If the detection apparatus includes a second optical splitting system, optical signals sent by H transceiver modules in the P transceiver modules may be split by the second optical splitting system. In other words, H optical signals in the at least one optical signal may be split by the second optical splitting system. For example, the second optical splitting system splits the H optical signals into K optical signals, the K optical signals may arrive at K micro reflectors, and the K micro reflectors may reflect the K optical signals. Remaining optical signals other than the H optical signals in the at least one optical signal do not pass through the second optical splitting system, but directly arrive at M-K micro reflectors, and the M-K micro reflectors may reflect the optical signals. For a manner of disposing the second optical splitting system, a manner of performing optical splitting by the second optical splitting system, and the like, refer to the foregoing related descriptions.

If the detection apparatus includes no zoom beam expansion system, the M micro reflectors may reflect the at least one optical signal to space. Alternatively, if the detection apparatus includes N zoom beam expansion systems, for example, the N zoom beam expansion systems correspond to one or more micro reflectors in the M micro reflectors, and a portion of or all optical signals in the at least one optical signal are reflected by the one or more micro reflectors, the optical signal reflected by the one or more micro reflectors arrives at the N zoom beam expansion systems, and then is transmitted to space through the N zoom beam expansion systems. For content of this part, refer to the foregoing related descriptions.

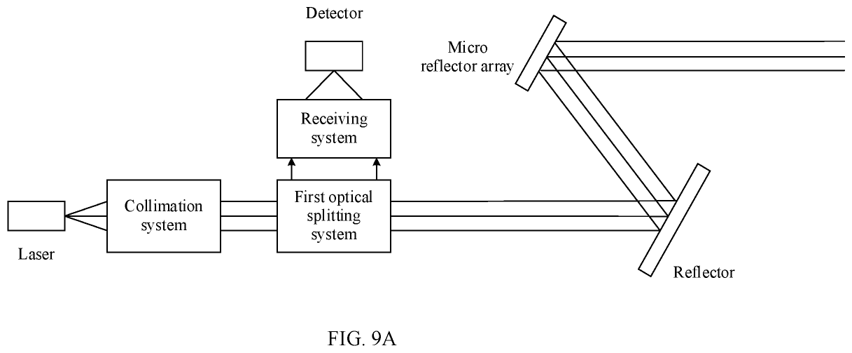

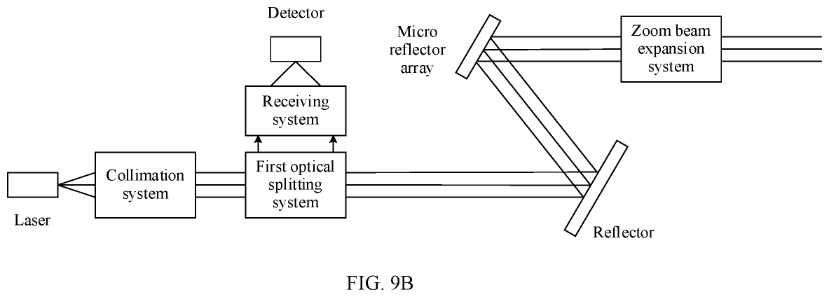

For example, refer to FIG. 9A. A process of sending an optical signal by a transceiver module is described. In FIG. 9A, an example in which the detection apparatus includes no second optical splitting system and no zoom beam expansion system is used. In addition, in FIG. 9A, an example in which the transceiver module is in a transmitting-receiving coaxial structure is used. In FIG. 9A, a laser included in the transceiver module sends an optical signal. The optical signal is collimated by a collimation system, and enters a first optical splitting system for optical splitting. An optical signal obtained through optical splitting is incident to a reflector included in the transceiver module. The reflector is, as described above, a reflector optionally included in the transceiver module, instead of a micro reflector included in a micro reflector array described in this embodiment of this application. After the optical signal obtained through optical splitting by the first optical splitting system arrives at the reflector, the reflector may reflect the optical signal to a micro reflector corresponding to the transceiver module in the micro reflector array. The micro reflector corresponding to the transceiver module reflects the received optical signal, to emit the optical signal into space.

For another example, refer to FIG. 9B. A process of sending an optical signal by another transceiver module is described. In FIG. 9B, an example in which the detection apparatus includes no second optical splitting system but includes a zoom beam expansion system is used. In addition, in FIG. 9B, an example in which the transceiver module is in a transmitting-receiving coaxial structure is used. In FIG. 9B, a laser included in the transceiver module sends an optical signal. The optical signal is collimated by a collimation system, and enters a first optical splitting system for optical splitting. An optical signal obtained through optical splitting is incident to a reflector included in the transceiver module, and the reflector may reflect the optical signal to a micro reflector corresponding to the transceiver module in the micro reflector array. The micro reflector corresponding to the transceiver module reflects the received optical signal, and the reflected optical signal enters the zoom beam expansion system, and is expanded and emitted into space by the zoom beam expansion system.

S803: The P transceiver modules receive an echo of the at least one optical signal reflected by the M micro reflectors.

After the detection apparatus sends the at least one optical signal, the at least one optical signal may be reflected back after arriving at a target object. A reflected signal is the echo of the at least one optical signal. Alternatively, after the detection apparatus sends the at least one optical signal, after arriving at a target object, the at least one optical signal is reflected by the target object to generate an echo, so that the detection apparatus can receive the echo of the at least one optical signal.

If the detection apparatus includes no zoom beam expansion system, the echo of the at least one optical signal arrives at the M micro reflectors, and the M micro reflectors may reflect the echo of the at least one optical signal, so that the reflected echo of the at least one optical signal arrives at the P transceiver modules. Alternatively, if the detection apparatus includes N zoom beam expansion systems, for example, the N zoom beam expansion systems correspond to one or more micro reflectors in the M micro reflectors, and as described above, a portion of or all optical signals in the at least one optical signal are reflected by the one or more micro reflectors, the optical signal reflected by the one or more micro reflectors arrives at the N zoom beam expansion systems, and then is transmitted to space through the N zoom beam expansion systems. Correspondingly, an echo of the portion of or all optical signals in the at least one optical signal arrives at the N zoom beam expansion systems, and arrives at the one or more micro reflectors through the N zoom beam expansion systems. The one or more micro reflectors may reflect the echo of the portion of or all optical signals in the at least one optical signal, so that the reflected echo of the portion of or all optical signals in the at least one optical signal arrives at a portion or all of the P transceiver modules. For a process of receiving and sending optical signals after the zoom beam expansion system is set, refer to the foregoing related descriptions.

If the detection apparatus includes no second optical splitting system, the M micro reflectors may send the reflected echo of the at least one optical signal to the P transceiver modules. Alternatively, if the detection apparatus includes a second optical splitting system, echoes of the K optical signals reflected by the K micro reflectors (where the K optical signals are split based on the H optical signals) may arrive at the second optical splitting system, the second optical splitting system may combine the echoes of the K optical signals into H echoes, the H echoes may arrive at the H transceiver modules, and M-K echoes reflected by M-K micro reflectors may directly arrive at P−H transceiver modules. In this way, the echo of the at least one optical signal arrives at the P transceiver modules. For example, if H=1, the second optical splitting system splits an optical signal sent by a transceiver module into K optical signals, and then combines received echoes of the K optical signals into one optical signal and sends the optical signal to the transceiver module. For another example, if H>1, the second optical splitting system includes optical splitting subsystems. For one of the optical splitting subsystems, an optical signal sent by a transceiver module corresponding to the optical splitting subsystem is split into at least two optical signals, and then received echoes of the at least two optical signals are combined into one optical signal and sent to the transceiver module. For a process of receiving and sending optical signals after the second optical splitting system is disposed, refer to the foregoing related descriptions.

For example, still refer to FIG. 9A. A process of receiving an optical signal by a transceiver module is described. In FIG. 9A, an echo of an optical signal sent by the transceiver module is incident to a micro reflector corresponding to the transceiver module in the micro reflector array. The micro reflector reflects the echo, to send the reflected echo to the first optical splitting system. The first optical splitting system then sends the received optical signal to a receiving system, and the echo of the optical signal may be obtained on a detector.

For example, still refer to FIG. 9B. A process of receiving an optical signal by a transceiver module is described. In FIG. 9B, an echo of an optical signal sent by the transceiver module is incident, through a zoom beam expansion system, to a micro reflector corresponding to the transceiver module in the micro reflector array. The micro reflector reflects the echo, to send the reflected echo to the first optical splitting system. The first optical splitting system then sends the received optical signal to a receiving system, and the echo of the optical signal may be obtained on a detector.

The M micro reflectors are disposed in the detection apparatus provided in this embodiment of this application, and M is an integer greater than or equal to 2. Therefore, the P transceiver modules do not need to receive and send signals by using one reflector, but may receive and send signals by using the M micro reflectors. In this way, a distortion degree of a point cloud formed by optical signals reflected by the micro reflectors is reduced, and accuracy of optical signals received and sent by the detection apparatus is improved. In addition, because a quantity of micro reflectors is increased, a quantity of transceiver modules may also be correspondingly increased, so that a plurality of transceiver modules may be spliced to obtain a larger field of view, so as to detect space in a larger range. In addition, because the zoom beam expansion system is disposed, a detection distance may also be correspondingly increased, so that both short-distance detection and long-distance detection can be implemented in this embodiment of this application.

Optionally, this embodiment of this application may further include the following steps.

S804: The N zoom beam expansion systems adjust a focal length, to change a scanning angle of the portion of or all optical signals in the at least one optical signal in space, or to change an angle of view of a field of view detected by a transceiver module corresponding to the N zoom beam expansion systems.

As described above, for example, a control unit may be disposed in the detection apparatus, or the control unit does not belong to the detection apparatus, but may be connected to the detection apparatus. The control unit may send a signal to trigger the detection apparatus, so that the detection apparatus implements signal sending. Optionally, the control unit may send a signal to trigger one or more zoom beam expansion systems in the N zoom beam expansion systems to adjust a focal length, to change a scanning angle, in space, of an optical signal that is transmitted by the one or more zoom beam expansion systems to space, so as to change a size of a field of view corresponding to the one or more zoom beam expansion systems. The optical signal transmitted by the one or more zoom beam expansion systems to space is the portion of or all optical signals in the at least one optical signal.

For example, it can be learned from the foregoing descriptions that a first zoom beam expansion system is disposed at a front end of a first micro reflector corresponding to a central field of view. The first zoom beam expansion system is, for example, the zoom beam expansion system shown in FIG. 7A. The first micro reflector is, for example, the micro reflector 2 shown in FIG. 7A. The central field of view is, for example, the field of view 2 shown in FIG. 7A. To detect a target object of interest in the central field of view, an angle of view of the central field of view needs to be reduced, or a scanning angle of an optical signal sent by the transceiver module 2 in space needs to be reduced. The control unit may send a first signal to the detection apparatus. After receiving the first signal, the detection apparatus may trigger the first zoom beam expansion system to adjust a focal length. An adjustment amount of the focal length may be determined by the first zoom beam expansion system, or the first signal may indicate an adjustment amount of the focal length. The first zoom beam expansion system can reduce, by adjusting the focal length, the scanning angle of the optical signal transmitted by the transceiver module 2 in space, and can also reduce a size of the field of view 2. Still refer to FIG. 7B, which is a schematic diagram obtained after the size of the field of view 2 is adjusted. It can be learned that the field of view 2 is reduced, so that one or more target objects of interest can be better focused on.

S805: The micro reflector array adjusts a rotation angle of at least one of the M micro reflectors, to change a scanning angle of an optical signal reflected by the at least one micro reflector in space.

Because an angle of view of the field of view 2 is adjusted, correspondingly, an angle of view of at least one field of view may be adjusted, so that the fields of view can be better spliced. If the at least one field of view corresponds to a zoom beam expansion system, the angle of view of the at least one field of view may be adjusted by adjusting a focal length of the zoom beam expansion system. If the at least one field of view corresponds to no zoom beam expansion system, the angle of view may be adjusted by adjusting at least one micro reflector corresponding to the at least one field of view. For example, the micro reflector array may adjust the rotation angle of the at least one of the M micro reflectors, to change the scanning angle of the optical signal reflected by the at least one micro reflector in space, so that the angle of view of the at least one field of view corresponding to the at least one micro reflector can be adjusted. For example, the control unit may send a second signal to trigger the at least one micro reflector to adjust the rotation angle, to change the scanning angle, in space, of the optical signal that is transmitted by the at least one micro reflector to space, so as to change the angle of view of the field of view corresponding to the one or more zoom beam expansion systems. An adjustment amount of the rotation angle may be determined by the at least one micro reflector, or the second signal may indicate an adjustment amount of the at least one micro reflector. Adjustment amounts of the at least one micro reflector may be the same or different. Still refer to FIG. 7B. For example, the at least one micro reflector includes the micro reflector 1 and the micro reflector 3. The micro reflector 1 may change the angle of view of the field of view 1 by adjusting the rotation angle, and the micro reflector 3 may change the angle of view of the field of view 3 by adjusting the rotation angle. For example, both the angle of view of the field of view 1 and the angle of view of the field of view 3 are increased. It can be learned from FIG. 7B that, after the angles of view of the field of view 1 and the field of view 3 are increased, the field of view 1, the field of view 2, and the field of view 3 may continue to implement better splicing, thereby reducing a blind area between the fields of view, and enabling the detection apparatus to improve space detection coverage.

S804 may occur before S805, or S804 may occur after S805, or S804 and S805 may occur at the same time. In addition, optional steps are represented by dashed lines in FIG. 8.

It can be learned that in this embodiment of this application, a focal length of a zoom beam expansion system and/or a rotation angle of a micro reflector are/is adjusted, so that a size of a field of view can be adjusted, and better splicing between fields of view can be implemented. In this way, the detection apparatus can detect a target of interest, and space detection coverage of the detection apparatus can also be improved.

An embodiment of this application further provides a radar, to provide a detection function for a vehicle. The radar includes at least one detection apparatus mentioned in embodiments of this application. The at least one detection apparatus in the system may be integrated into an entire system or a device, or the at least one detection apparatus in the system may be independently disposed as an element or an apparatus.

An embodiment of this application further provides a vehicle. The vehicle includes at least one detection apparatus mentioned in embodiments of this application, or includes the radar mentioned in the foregoing embodiment of this application. The detection apparatus is disposed in the radar.

When the several embodiments provided in this application are implemented in a form of a software functional unit and sold or used as an independent product, the embodiments may be stored in a computer-readable storage medium. The computer software product is stored in a storage medium, and includes several instructions for instructing a computer device (which may be a personal computer, a server, a network device, or the like) to perform all or some of the steps of the method described in embodiments of this application. The computer-readable storage medium may be any usable medium that can be accessed by a computer. The following provides an example but does not impose a limitation. The computer readable medium may include a random-access memory (RAM), a read-only memory (ROM), or any other medium that can be used to carry or store expected program code in a form of an instruction or a data structure and can be accessed by a computer.

The foregoing descriptions are implementations of this application, and are not intended to limit the protection scope of embodiments of this application. Any variation or replacement readily figured out by a person skilled in the art within the technical scope disclosed in embodiments of this application shall fall within the protection scope of embodiments of this application. Therefore, the protection scope of embodiments of this application shall be subject to the protection scope of the claims.

1. A detection apparatus comprising:
a scanner comprising a micro reflector array, wherein the micro reflector array comprises M micro reflectors, wherein the M micro reflectors are configured to reflect optical signals, and wherein M is an integer greater than or equal to 2; and
P transceivers communicatively coupled to the scanner, wherein P is a positive integer less than or equal to M, and wherein the P transceivers are configured to:
transmit the optical signals; and/or
receive the optical signals reflected by the M micro reflectors.

2. The detection apparatus ae of claim 1, wherein the detection apparatus further comprises N beam expansion systems configured to:
receive, from the P transceivers, a portion of or all of the optical signals through one or more of the M micro reflectors, wherein N is a positive integer less than or equal to M; and
change a detection range of the detection apparatus; and/or
the P transceivers are further configured to receive a first optical signal of the optical signals that arrives at one or more of the M micro reflectors through the N beam expansion systems and that is reflected by the one or more micro reflectors.

3. The detection apparatus of claim 2, wherein a first transceiver of the P transceivers is configured to:
transmit a second optical signal, and/or
receive a third optical signal that arrives at a first micro reflector of the M micro reflectors through a first beam expansion system of the N beam expansion systems and that is reflected by the first micro reflector,
wherein the N beam expansion systems comprise a first beam expansion system and configured to receive the second optical signal through the first micro reflector, and wherein the first micro reflector is located in a middle position of the M micro reflectors.

4. The detection apparatus of claim 1, wherein each of the P transceivers comprises a laser, a collimation system, an optical splitting system, and a receiving system.

5. The detection apparatus of claim 1, wherein H transceivers in the P transceivers are configured to transmit H optical signals of the optical signals, wherein the detection apparatus further comprises an optical splitting system when P is less than M, wherein the optical splitting system is configured to split the H optical signals into K optical signals, wherein H is an integer greater than or equal to 1 and less than or equal to P, and wherein K is an integer greater than or equal to 2 and less than or equal to M.

6. The detection apparatus of claim 1, wherein at least one of the M micro reflectors is a micro-mechanical system (MEMS) reflector.

7. The detection apparatus of claim 1, wherein a first transceiver of the P transceivers is configured to:
transmit a first optical signal to be reflected by a first micro reflector of the M micro reflectors corresponding to the first transceiver; and/or
receive a second optical signal from the first micro reflector,
wherein P is equal to M, and
wherein the P transceivers are in a one-to-one correspondence with the M micro reflectors.

8. The detection apparatus of claim 1, wherein one of the P transceivers is in a transmitting-receiving coaxial structure, and wherein the transmitting-receiving coaxial structure indicates that a first optical signal sent by the one of the P transceivers and a second optical signal received by the one of the P transceivers pass through a same path.

9. A detection method implemented by a detection apparatus, wherein the detection method comprises:
transmitting, by P transceivers of the detection apparatus, at least one optical signal;
reflecting, by M micro reflectors of a micro reflector array of the detection apparatus, the at least one optical signal, wherein M is an integer greater than or equal to 2, wherein N is a positive integer less than or equal to M, and wherein P is a positive integer less than or equal to M; and
receiving, by the P transceivers, an echo of the at least one optical signal reflected by the M micro reflectors.

10. The detection method of claim 9, further comprising:
changing, by N beam expansion systems of the detection apparatus, a detection range of the detection apparatus;
enabling a portion of optical signals in the at least one optical signal to arrive at the N beam expansion systems after being reflected by one or more of the M micro reflectors and to be transmitted by the N beam expansion systems; and
receiving, by the P transceivers, a second echo of the portion of or all of the optical signals.

11. The detection method of claim 10, further compromising adjusting, by the N beam expansion systems, a focal length to change a scanning angle of the portion of or all the optical signals in space.

12. The detection method of claim 9, further comprising adjusting, by the micro reflector array, a rotation angle of at least one of the M micro reflectors to change a scanning angle of an optical signal reflected by the at least one micro reflector in space.

13. The detection method of claim 12, wherein after adjusting the rotation angle the method further comprises:
increasing the scanning angle, and
removing a blind area between a first field of view formed in the space by a portion of or all optical signals in the at least one optical signal and a second field of view formed in the space by the optical signal.

14. The detection method of claim 9, wherein each of the P transceivers comprises a laser, a collimation system, an optical splitting system, and a receiving system.

15. The detection method of claim 14, wherein P is less than M, and wherein the method further comprises:
splitting, by an optical splitting system of the detection apparatus, H optical signals in the at least one optical signal into K optical signals, wherein the H optical signals are from H transceivers in the P transceivers, wherein H is an integer greater than or equal to 1 and less than or equal to P, and wherein K is an integer greater than or equal to 2 and less than or equal to M;
reflecting, by K micro reflectors, the H optical signals; and
reflecting, by M-K micro reflectors in the M micro reflectors, P−H optical signals in the at least one optical signal.

16. The detection method of claim 9, wherein a first micro reflector is a micro-electro-mechanical system (MEMS) reflector.

17. The detection method claim 9, wherein one of the P transceivers is in a transmitting-receiving coaxial structure, and wherein the transmitting-receiving coaxial structure indicates that a first optical signal sent by the one of the P transceivers and a second optical signal received by the one of the P transceivers pass through a same path.

18. A light detection and ranging or laser imaging, detection, and ranging (lidar) system comprising:
an optical splitting system configured to split an incident optical signal into optical signals; and
a detection apparatus coupled to the optical splitting system and comprising:
a scanner comprising a micro reflector array, wherein the micro reflector array comprises M micro reflectors, wherein the M micro reflectors are configured to reflect the optical signals, and wherein M is an integer greater than or equal to 2; and
P transceivers communicatively coupled to the scanner and configured to:
transmit the optical signals; and/or
receive the optical signals reflected by the M micro reflectors wherein P is a positive integer less than or equal to M.

19. The lidar system of claim 18, wherein the detection apparatus further comprises N beam expansion systems configured to:
receive, from the P transceivers, a portion of or all optical signals through one or more of the M micro reflectors, wherein N is a positive integer less than or equal to M, and
change a detection range of the detection apparatus; and/or
the P transceivers are further configured to receive an optical signal that arrives at one or more of the M micro reflectors through the N beam expansion systems and that is reflected by the one or more micro reflectors.

20. The lidar system of claim 19, wherein a first transceiver of the P transceivers is configured to:
transmit a first optical signal; and/or
receive a second optical signal that arrives at a first micro reflector of the M micro reflectors through a first beam expansion system of the N beam expansion systems and that is reflected by the first micro reflector,
wherein the first beam expansion system is configured to receive the first optical signal a through the first micro reflector, and
wherein the first micro reflector is located in a middle position of the M micro reflectors.
